(19) United States
(12) Patent Application Publication
(10) Pub. No.: US 2008/0158188 A1
(43) Pub. Date: Jul. 3, 2008

(54) Information Processing Apparatus and Information Processing Method

(76) Inventors: Hiroyuki Tsuji, Oume-shi (JP); Yoshihisa Suzuki, Fussa-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/828,159

(22) Filed: Jul. 25, 2007

(30) Foreign Application Priority Data
Dec. 27, 2006 (JP) 2006-352314

(51) Int. Cl. G06F 3/041

(52) U.S. Cl. 345/173

(57) ABSTRACT

One embodiment of the invention provides an information processing apparatus including: a signal generation unit that detects an open/close state of a display panel to generate a detection signal; a first determination unit that determines whether or not the open/close state of the display panel is changed based on the detection signal generated by the generation unit; a notification unit that notifies a confirmation request for confirming the status of the tablet device; an acquisition unit that acquires the status of the tablet device in response to the confirmation request by the notification unit; a second determination unit that determines whether the status of the tablet device acquired by the acquisition unit is valid or not; and a first controller that controls a function of the tablet device to be enabled or disabled based on the status of the tablet device.

### CROSS-REFERENCE TO RELATED APPLICATIONS

This application is based upon and claims the benefit of priority from Japanese Patent Application No. 2006-352314, filed on Dec. 27, 2006, the entire contents of which are incorporated herein by reference.

### BACKGROUND

1. Field

One embodiment of the invention relates to an information processing apparatus and an information processing method, and more particularly to an information processing apparatus including a tablet device and an information processing method for the apparatus.

2. Description of the Related Art

In recent years, a personal computer including a tablet device capable of detecting the coordinate value of a point whose position is indicated by, for example, a pen, has been proposed. Such personal computer includes a housing and a liquid crystal display, for example, on one face of the housing. The tablet device is disposed on the front or back face of the liquid crystal display.

Conventionally, the input from the tablet device is generally controlled by determining whether or not input information from the tablet device is accepted while a tablet device function is enabled at any time (e.g., refer to Japanese Patent Application Publication (KOKAI) No. 2005-149109).

This publication discloses a technique to switch user interfaces by determining whether or not current input mode is for the tablet device. Thereby, by determining if the current input mode is for a note mode or for the tablet mode, it is possible to provide the user interface suitable for each mode to the user.

Incidentally, with the technique as proposed in the publication, the information processing apparatus is controlled while the tablet device function is enabled at an Operating System (OS) level (including a resident application program) at any time, irrespective of whether the display panel is open or closed.

Specifically, when the display panel is closed, the tablet device is invalidated (disabled, in other words, a state where a pen device of the tablet device is unusable by the application program) at the OS level, and the power is turned OFF in this state. Thereafter, when the display panel is opened, the power is turned ON.

However, for example, a Login (Logon) process on a Login (Logon) screen can not be performed until a screen open/close status confirmation application starts.

When a display process is performed on an external display device in the state where the display panel is closed, the tablet device is affected by the noise from the main body (base portion) of the personal computer. Therefore, a noise filtering process with Fire Wire (FW) is necessary at the tablet device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the appearance of a personal computer applicable to an information processing apparatus according to an embodiment of the present invention;

FIG. 2 is an exemplary block diagram showing the internal configuration of the personal computer applicable to the information processing apparatus according to the embodiment;

FIG. 3 is an exemplary flowchart for explaining a tablet device status setting process in the personal computer of FIG. 2;

FIG. 4 is an exemplary flowchart for explaining a tablet device status confirmation request notification process in the personal computer of FIG. 2;

FIG. 5 is an exemplary flowchart for explaining a tablet device function enable/disable process in the personal computer of FIG. 2;

FIG. 6 is an exemplary transition diagram showing the transition of an enabled/disabled state for the tablet device according to the state of the display panel of FIG. 1; and

FIG. 7 is an exemplary flowchart for explaining another tablet device status confirmation notification process in the personal computer of FIG. 2.

### DETAILED DESCRIPTION

Various embodiments according to the invention will be described hereinafter with reference to the accompanying drawings. In general, according to one embodiment of the invention, an information processing apparatus includes: a signal generation unit that detects an open/close state of a display panel to generate a detection signal; a first determination unit that determines whether or not the open/close state of the display panel is changed based on the detection signal generated by the generation unit; a notification unit that notifies a confirmation request for confirming the status of the tablet device; an acquisition unit that acquires the status of the tablet device in response to the confirmation request by the notification unit; a second determination unit that determines whether the status of the tablet device acquired by the acquisition unit is valid or not; and a first controller that controls a function of the tablet device to be enabled or disabled based on the status of the tablet device.

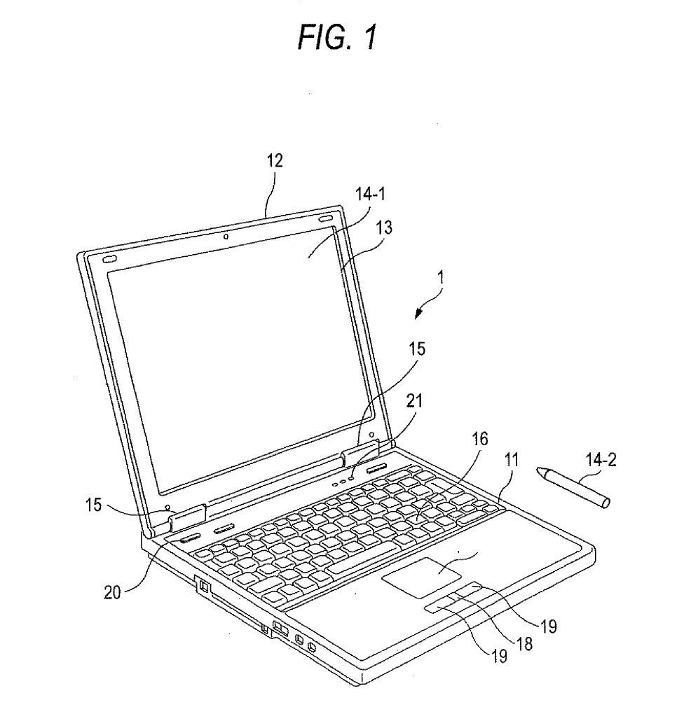

FIG. 1 shows the exemplary appearance of a notebook type personal computer 1 applicable to an information processing apparatus according to an embodiment of the present invention.

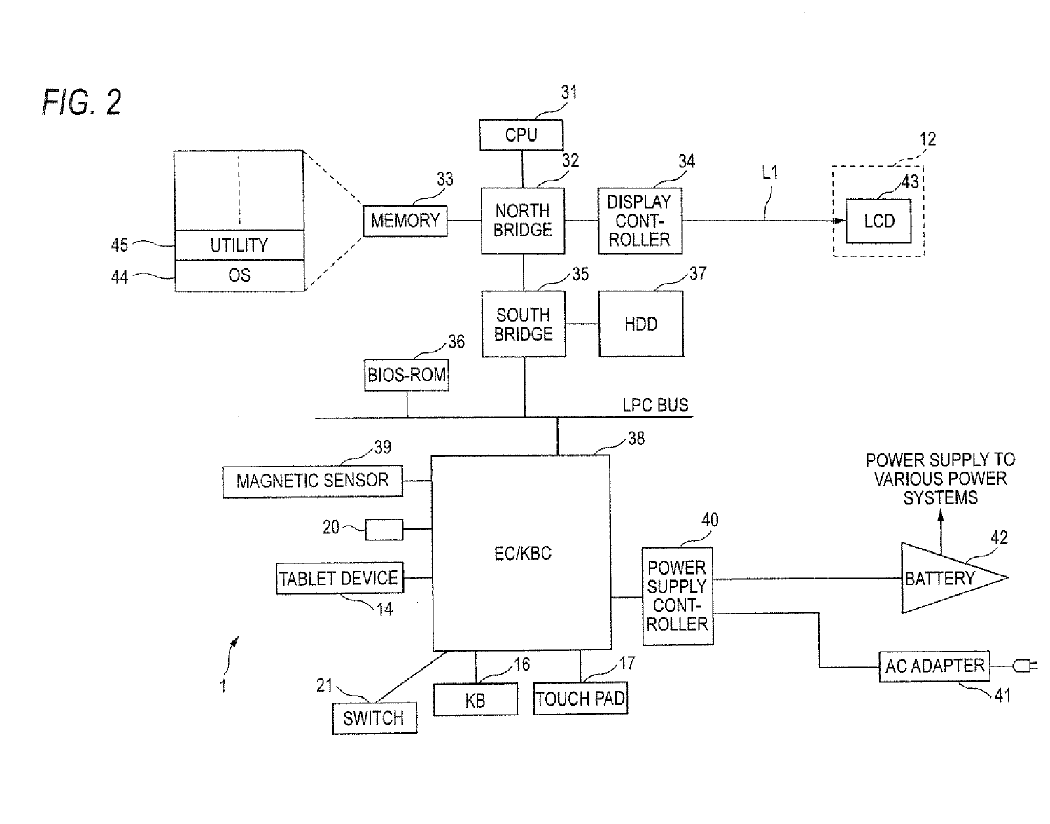

The personal computer 1 comprises a computer main body 11 and a display unit 12. The display unit 12 is built in a display panel 13 having a Liquid Crystal Display (LCD 43 in FIG. 2) and a tablet device 14-1. The LCD 43 is provided in the display unit 12 at the almost center thereof, and the tablet device 14-1 is provided on the front face of the LCD 43, for example. Of course, the tablet device 14-1 may be provided on the back face of the LCD 43, for example.

The personal computer 1 is provided with a pen 14-2 for indicating the input positional information to the tablet device 14-1.

In the following, in the case where it is unnecessary to distinguish the tablet device 14-1 from the pen 14-2, they are simply denoted as the “tablet device 14”.

The display unit 12 is mounted around the hinges 15 provided at one end of a computer main body 11 so that the display unit 12 rotates between a closed position in which the top face of the computer main body 11 is covered and an open position in which the top face of the computer main body 11 is exposed.

The computer main body 11 has a thin box-like housing, in which a keyboard 16 is provided in the central part on the top face of the housing. A palm rest is formed on the top face of the housing on the front side of the computer main body 11. A touch pad 17, a scroll button 18 and the touch pad control buttons 19 are provided in the almost center part of the palm rest. A power button 20 for turning on or off the power of the personal computer 1 and various switches 21 are disposed on the top face of the housing on the back side of the computer main body 11.

FIG. 2 shows an exemplary internal configuration of the personal computer 1.

The personal computer 1 comprises a CPU 31, a north bridge 32, a main memory 33, a graphics controller 34, a south bridge 35, a BIOS-ROM 36, a hard disk drive (HDD) 37, an embedded controller/keyboard controller IC (EC/KBC) 38, a magnetic sensor 39 and a power supply controller 40, as shown in FIG. 2.

The display unit 12 includes the LCD 43.

The Central Processing unit (CPU) 31 is a processor provided to control the operation of the personal computer 1 and executes an operating system (OS) 44 and various kinds of application program including a utility 45 loaded from the HDD 37 into the main memory 33.

Also, the CPU 31 executes a system BIOS (Basic Input Output System) loaded into the main memory 33, after loading the system BIOS stored in the BIOS-ROM 36 into the main memory 33. The system BIOS is a program for hardware control.

The north bridge 32 is a bridge device connecting a local bus in the CPU 31 and the south bridge 35. The north bridge 32 internally comprises a memory controller for controlling access to the main memory 33. Also, the north bridge 32 has a function (e.g., an AGP controller) of making the communication with the graphics controller 34 via an Accelerated Graphic Port (AGP) bus, for example.

The graphics controller 34 is a display controller for controlling the red pixels, green pixels and blue pixels of the LCD 45 for use as a display monitor of the personal computer 1. This graphics controller 34 has a video memory (Video RAM (VRAM)) that generates a video signal for forming the display image (picture) to be displayed on the LCD 45 from display data (image data or text data) rendered (generated) on the video memory by the OS/application program. The video signal as a control signal generated by the graphics controller 34 is outputted to a signal line L1.

The EC/KBC 38 controls the keyboard 16, the touch pad 17, the scroll button 18, the touch pad control button 19, and the switches 21 as input means. Also, the EC/KBC 38 controls the tablet device 14. The EC/KBC 38 is one-chip microcomputer for monitoring and controlling various devices (peripheral devices, sensors, a power supply circuit, etc.), irrespective of the system state of the personal computer 1 (i.e., even though the power of the personal computer is off).

Further, the EC/KBC 38 determines a state (i.e., open state or closed state) of the display panel 13 of the personal computer 1, based on a detection signal supplied from magnetic sensors 39 (e.g., a plurality of magnetic sensors 39 opposed with each other) provided at a predetermined position of the personal computer 1.

The plurality of magnetic sensors 39 are provided at predetermined positions (e.g., opposed positions) of the personal computer 1 to detect the state (i.e., open state or closed state) of the display panel 13 of the personal computer a and generate the detection signal.

In the case where an external power is supplied via an AC adapter 41, the power supply controller 40 prepares a system power to be supplied to each component of the personal computer 1, employing the external power supplied from the AC adapter 41. Also, in the case where the external power is not supplied via the AC adapter 41, the power supply controller 40 prepares a system power to be supplied to each component (personal computer main body 11 and display unit 12) of the personal computer 1, employing a battery 42.

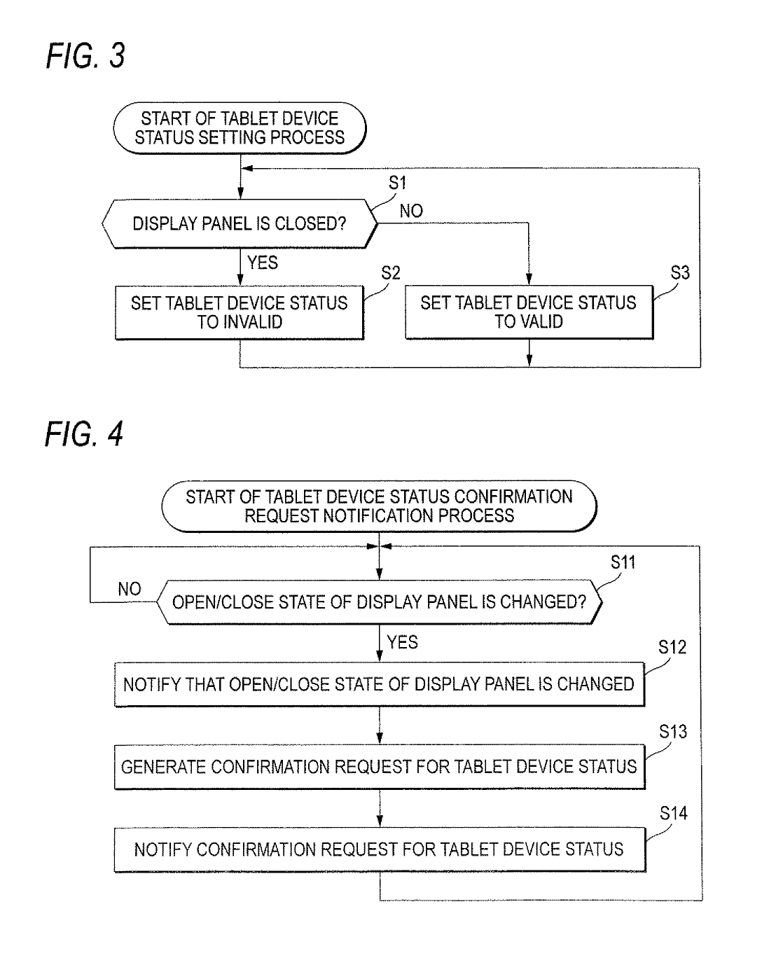

Referring to a flowchart of FIG. 3, a tablet device status setting process for the personal computer 1 of FIG. 2 will be described below. This tablet device status setting process is started properly when the user operates the display panel 13 to open or close the display panel 13.

At block S1, if the user operates the display panel 13 to open or close the display panel 13, the magnetic sensor 39 detects the state (i.e., open state or closed state) of the personal computer 1 to generate a detection signal and supply the generated detection signal to the EC/KBC 38.

The EC/KBC 38 determines whether or not the state of the display panel 13 of the personal computer 1 is the closed state, based on the detection signal supplied from the magnetic sensor 39.

If it is determined at block S1 that the state of the display panel 13 of the personal computer 1 is the closed state, the EC/KBC 38 notifies the system BIOS that the state of the display panel 13 of the personal computer 1 is the closed state.

At block S2, the CPU 31 executes the system BIOS loaded on the main memory 33, and sets a tablet device status indicating a status of the tablet device 14 to invalid, if it receives a notification that the state of the display panel 13 of the personal computer 1 is the closed state from the EC/KBC 38. That is, the tablet device 14 is inoperable, and set in a state unrecognizable by the OS.

On the other hand, if it is determined at block S1 that the state of the display panel 13 of the personal computer 1 is not the closed state (i.e., if it is determined that the state of the display panel 13 of the personal computer 1 is the open state), the EC/KBC 38 notifies the system BIOS that the state of the display panel 13 of the personal computer 1 is the open state.

At block S3, the CPU 31 executes the system BIOS loaded on the main memory 33, and sets the tablet device status that is the status of the tablet device 14 to valid, if it receives a notification that the state of the display panel 13 of the personal computer 1 is the open state from the EC/KBC 38. That is, the tablet device 14 is operable, and set in a state recognizable by the OS.

Thereafter, the process from block S1 to block S3 is repeated, as needed. Thereby, when the user operates the display panel 13 to open or close the display panel 13, the tablet device status indicating the status of the tablet device 14 is properly set to valid or invalid.

Referring to a flowchart of FIG. 4, a tablet device status confirmation request notification process for the personal computer 1 of FIG. 2 will be described below. This tablet device status confirmation request notification process is started properly in parallel with the tablet device status setting process as described using the flowchart of FIG. 3, when the user operates the display panel 13 to open or close the display panel 13. Of course, this tablet device status confirmation request notification process may be started not in parallel with but after the tablet device status setting process as described using the flowchart of FIG. 3.

At block S11, if the user operates the display panel 13 to open or close the display panel 13, the magnetic sensor 39 detects the open/close state (i.e., open state or closed state) of the display panel 13 of the personal computer 1 to generate a detection signal and supply the generated detection signal to the EC/KBC 38.

The EC/KBC 38 determines whether or not the open/close state of the display panel 13 of the personal computer 1 is changed (i.e., determines whether the open/close state of the display panel 13 of the personal computer 1 is changed from the closed state to the open state or from the open state to the closed state, based on the detection signal supplied from the magnetic sensor 39), and waits until it is determined that the open/close state of the display panel 13 of the personal computer 1 is changed.

If it is determined at block S11 that the open/close state of the display panel 13 of the personal computer 1 is changed, the EC/KBC 38 notifies the system BIOS that it is determined that the open/close state of the display panel 13 of the personal computer 1 is changed.

At block S12, the CPU 31 executes the system BIOS loaded on the main memory 33, and notifies the OS 44 loaded on the main memory 33 that the open/close state of the display panel 13 of the personal computer 1 is changed (i.e., the open/close state of the display panel 13 of the personal computer 1 is changed from the closed state to the open state or from the open state to the closed state), if the system BIOS receives a notification of determining that the open/close state of the display panel 13 of the personal computer 1 is changed from the EC/KBC 38.

At block S13, the CPU 31 executes the system BIOS loaded on the main memory 33 and generates a confirmation request for confirming the tablet device status indicating the status of the tablet device 14.

At block 314, the CPU 31 executes the system BIOS loaded on the main memory 33, and notifies the generated confirmation request of the tablet device status to the OS 44.

Returning to block S11, the process following block S11 is repeatedly performed. Thereby, every time the open/close state of the display panel 13 of the personal computer 1 is changed, it is notified to the OS 44 that the open/close state of the display panel 13 is changed, and a confirmation request for the tablet device status is generated and notified to the OS 44.

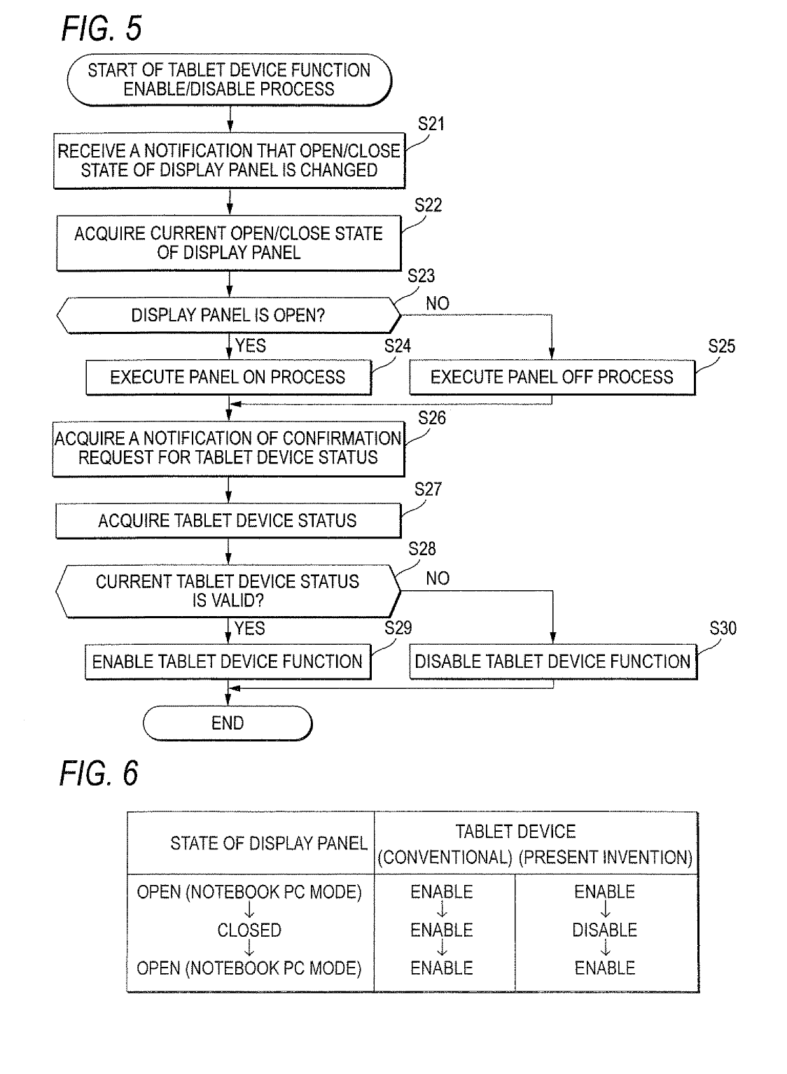

Referring to a flowchart of FIG. 5, a tablet device function enable/disable process for the personal computer 1 of FIG. 2 will be described below. This tablet device function enable/disable process is started when the OS 44 receives a notification that the open/close state of the display panel 13 is changed from the system BIOS loaded on the main memory 33.

At block S21, the CPU 31 executes the OS 44 loaded on the main memory 33, and receives a notification that the open/close state of the display panel 13 is changed (i.e., a notification as to whether the open/close state of the display panel 13 of the personal computer 1 is changed from the closed state to the open state or from the open state to the closed state) from the system BIOS loaded on the main memory 33.

At block S22, the CPU 31 executes the OS 44 loaded on the main memory 33, and acquires the current open/close state of the display panel 13 (i.e., whether the state of the display panel 13 of the personal computer 1 is the open or closed state), based on the notification that the open/close state of the display panel 13 is changed, which is acquired from the system BIOS.

At block S23, the CPU 31 executes the OS 44 loaded on the main memory 33, and determines whether or not the state of the display panel 13 of the personal computer 1 is the open state, based on the acquired current open/close state of the display panel 13.

If it is determined at block S23 that the state of the display panel 13 of the personal computer 1 is the open state, the CPU 31 executes the OS 44 loaded on the main memory 33 to perform a panel ON process for validating the display panel 13 of the personal computer 1 at block 324.

On the other hand, if it is determined at block S23 that the state of the display panel 13 of the personal computer 1 is not the open state (i.e., it is determined that the state of the display panel 13 of the personal computer 1 is the closed state), the CPU 31 executes the OS 44 loaded on the main memory 33 to perform a panel OFF process for invalidating the display panel 13 of the personal computer 1 at block S25.

At block S26, the CPU 31 executes the OS 44 loaded on the main memory 33, and acquires a notification of the confirmation request for the tablet device status from the system BIOS.

At block S27, the CPU 31 executes the OS 44 loaded on the main memory 33, and acquires a status (valid or invalid status) of the tablet device 14 set by the system BIOS in accordance with the notification of the confirmation request for the tablet device status acquired from the system BIOS.

At block S28, the CPU 31 executes the OS 44 loaded on the main memory 33, and determined whether or not the current status of the tablet device 14 is valid, based on the acquired tablet device status.

If it is determined at block S28 that the current status of the tablet device 14 is valid, the CPU 31 executes the OS 44 loaded on the main memory 33 to perform an enabling process for enabling the tablet device function that is the function of the tablet device 14 at block S29.

On the other hand, if it is determined at block S28 that the current status of the tablet device 14 is not valid (i.e., it is determined that the current status of the tablet device 14 is invalid), the CPU 31 executes the OS 44 loaded on the main memory 33 to perform a disabling process for disabling the tablet device function that is the function of the tablet device 14 at block S30.

With the conventional art, when the personal computer 1 is opened or closed, the tablet device 14 is enabled at any time. On the other hand, according to this embodiment, when the personal computer 1 is changed from the open state to the closed state, the function of the tablet device 14 is switched from an enabled state to a disabled state, and when the personal computer 1 is changed from the closed state to the open state, the function of the tablet device 14 is switched form the disabled state to the enabled state, as shown in FIG. 6, for example.

In the embodiment of the present invention, it may be possible to detect and notify that the open/close state of the display panel 13 is changed, and generate and notify a confirmation request for the status of the tablet device 14.

And if the notification of the confirmation request for the status of the tablet device 14 is acquired, the status (valid or invalid status) of the tablet device 14 is acquired, and it is determined whether or not the acquired status of the tablet device 14 is valid. If it is determined that the acquired status of the tablet device 14 is valid, the enabling process for enabling the function of the tablet device 14 is performed, or if it is determined that the acquired status of the tablet device 14 is invalid, the disabling process for disabling the function of the tablet device 14 is performed.

Thereby, when the personal computer 1 is changed from the open state to the closed state, the tablet device 14 is unrecognizable (recognized as unseen) by the OS 44, whereby the function of the tablet device 14 is switched from the enabled state to the disabled state. When the personal computer 1 is changed from the closed state to the open state, the tablet device 14 is recognizable (recognized as seen) by the OS 44, whereby the function of the tablet device 14 is switched from the disabled state to the enabled state.

Accordingly, when the display process is performed on the external display device (not shown) in the state where the display panel 13 is closed, for example, the function of the tablet device 14 is disabled, whereby the tablet device 14 is not affected by the noise from the computer main body 11 (base portion) of the personal computer 1, and it is unnecessary that the noise filtering process with Fire Wire is performed on the side of the tablet device 14. Also, the system BIOS singly can shut out the influence of the noise on the tablet device 14. As a result, the load of the CPU 31 can be reduced, and the responsivity of the pen 14-2 on the tablet device 14 can be improved.

As described above, the availability of the tablet device can be improved.

Incidentally, with the technique as proposed in Japanese Patent Application Publication (KOKAI) No. 2005-149109, the information processing apparatus is controlled while the tablet device function is enabled at an OS level (including a resident application program) at any time, irrespective of whether the display panel is open or closed.

Specifically, when the display panel is closed, the tablet device is invalidated (disabled, in other words, a state where the pen device of the tablet device is unusable by the application program) at the OS level, and the power is turned OFF in this state. Thereafter, when the display panel is opened, the power is turned ON.

However, for example, a Login process on a Login screen can not be performed using the tablet device 14, until the screen open/close status confirmation application starts.

Thus, the enable/disable state of the tablet device 14 is linked with the open/close state of the display panel 13 at the time of starting the OS 44, whereby when it is detected that the display panel 13 is changed into the open state at the time of starting the OS, the tablet device 14 is recognizable by the OS 44 to enable the function of the tablet device 14. On the other hand, when the OS 44 is started while the display process is performed using the external display device (not shown) in the state where the display panel 13 is closed, the function of the tablet device 14 is disabled. In the following, another tablet device status confirmation request notification process for the personal computer 1 of FIG. 2 with this method will be described below.

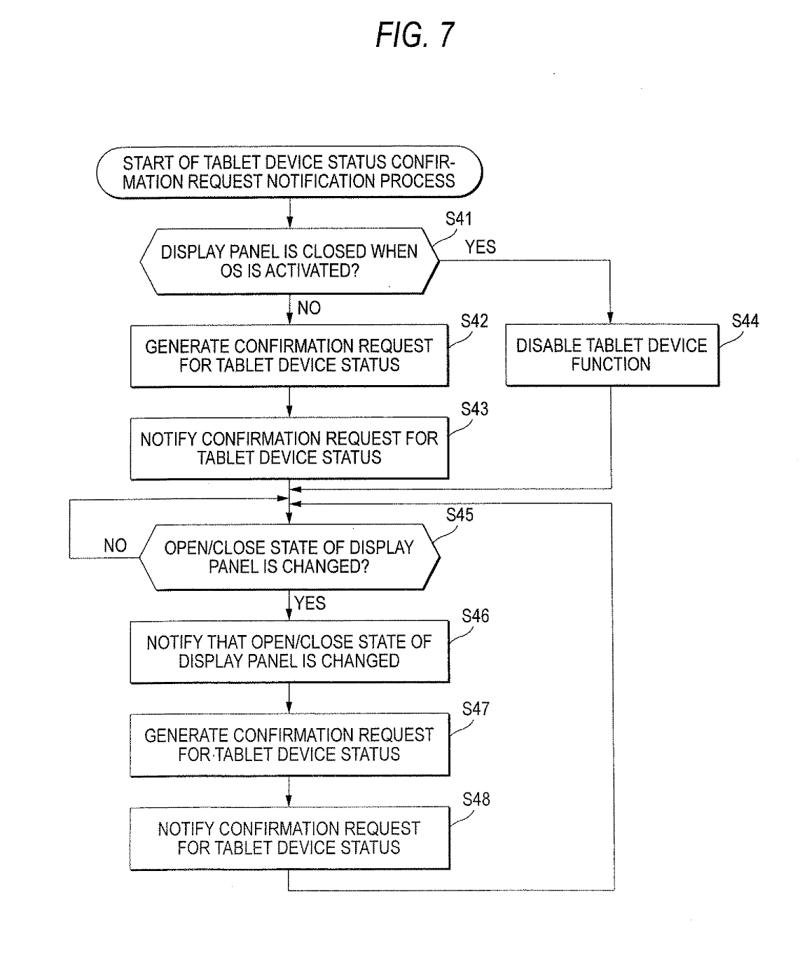

Referring to a flowchart of FIG. 7, another tablet device status confirmation request notification process for the personal computer 1 of FIG. 2 will be described below. The process from block S45 to block S48 in FIG. 7 is similar to the process from block S11 to block S14 in FIG. 4, which has been already described. Thus, the duplicate explanation is omitted. This tablet device status confirmation request notification process is started when the user presses the switch 21 to perform the start process of the personal computer 1, for example.

At block S41, when the user operates the switch 21, for example, to perform the start process of the personal computer 1, the magnetic sensor 39 detects the state (i.e., open state or closed state) of the personal computer 1 to generate a detection signal and supply the generated detection signal to the EC/KBC 38.

The EC/KBC 38 determines whether or not the state of the display panel 13 of the personal computer 1 is the closed state when the OS 44 is activated, based on the detection signal supplied from the magnetic sensor 39.

If it is determined at block S41 that the state of the display panel 13 of the personal computer 1 is not the closed state when the OS 44 is activated (i.e., it is determined that the state of the display panel 13 of the personal computer 1 is the open state when the OS 44 is activated because the user opens the display panel 13), the EC/KBC 38 notifies the system BIOS that the state of the display panel 13 of the personal computer 1 is the open state when the OS 44 is activated.

At block S42, the CPU 31 executes the system BIOS loaded on the main memory 33, and generates a confirmation request for confirming the tablet device status indicating the status of the tablet device 14 for the change in the open/close state of the display panel 13, if it receives a notification that the state of the display panel 13 of the personal computer 1 is the open state when the OS 44 is activated from the EC/KBC 38.

At block S43, the CPU 31 executes the system BIOS loaded on the main memory 33 and notifies the generated confirmation request for the tablet device status to the OS 44.

Thereafter, the operation goes to block S45, whereby the process following block S45 is repeatedly performed. That is, the enable/disable state of the tablet device 14 is linked with the open/close state of the display panel 13 when the OS 44 is activated, whereby the operation transits smoothly to the tablet device status confirmation request notification process after activating the OS 44, to perform the tablet device function enable/disable process as described using the flowchart of FIG. 5.

On the other hand, if it is determined at block S41 that the state of the display panel 13 of the personal computer 1 is the closed state when the OS 44 is activated (i.e., when the OS 44 is started while the display process is performed using the external display device (not shown) in the state where the display panel 13 is closed), the EC/KBC 38 notifies the system BIOS that the state of the display panel 13 of the personal computer 1 is the closed state when the OS 44 is activated.

At block S44, the CPU 31 executes the system BIOS loaded on the main memory 33, and performs a disabling process for disabling the function of the tablet device 14 so that the tablet device 14 may not be recognized by the OS 44 to be started, if the system BIOS receives a notification that the state of the display panel 13 of the personal computer 1 is the closed state when the OS 44 is activated, from the EC/KBC 38.

Thereby, when the OS 44 is started while the display process is performed using the external display device (not shown) in the state where the display panel 13 is closed, the function of the tablet device 14 is disabled.

Accordingly, when the OS 44 is started while the display process is performed using the external display device (not shown) in the state where the display panel 13 is closed, the function of the tablet device 14 is disabled by the system BIOS, so that the tablet device 14 is not affected by the noise from the computer main body 11 (base portion) of the personal computer 1, and it is unnecessary that the noise filtering process with Fire Wire is performed on the side of the tablet device 14. Also, the system BIOS singly can shut out the influence of the noise on the tablet device 14.

On the other hand, when the OS 44 is started using the display panel 13 of the personal computer 1, but not the external display device (not shown), and when the display panel 13 is open, the tablet device 14 is recognizable by the OS 44, whereby the function of the tablet device 14 is enabled. As a result, a Login process on a Login screen, for example, can be performed using the tablet device 14, before the screen open/close status confirmation application starts.

In the above manner, the availability of the tablet device can be further improved.

An exclusive switch 21 (or the keyboard 16 or any other button) for switching the tablet device 14 between the enabled state and the disabled state when or after starting the OS may be provided, in which every time the user presses the exclusive switch 21, the function of the tablet device 14 may be switched between the enabled state and the disabled state. Thereby, when the user employs the personal computer 1 in a notebook PC mode, the pen 14-2 is mostly not employed, whereby the function of the tablet device 14 is disabled suitably and simply to suit the preferences of the user. Accordingly, the availability of the tablet device can be further improved.

This embodiment of the present invention may be also applicable to the tablet device 14 as the existent serial device (serial transfer type device).

Further, the display panel 13 applied to the embodiment of the present invention may include the tablet device 14 and a flat panel display, or a protection panel that covers the tablet device 14.

This embodiment of the present invention may be applied to a Personal Digital Assistant (PDA), a handy game machine, a portable music sound-reproducing system, a portable animation reproducing system, and other information processing apparatuses, in addition to the personal computer 1.

A series of processes as described above in the embodiment of the present invention may be performed by software or hardware.

Moreover, though in the embodiment of the invention, the steps of the flowchart are performed in time series according to the prescribed sequence, those steps are not necessarily performed in time series, but may be performed in parallel or individually.

According to the configuration, the availability of the tablet device can be improved.

The present invention provides illustrative, non-limiting embodiments as follows:

An information processing apparatus includes: a signal generation unit that detects an open/close state of a display panel to generate a detection signal; a first determination unit that determines whether or not the open/close state of the display panel is changed based on the detection signal generated by the generation unit; a notification unit that notifies a confirmation request for confirming the status of the tablet device; an acquisition unit that acquires the status of the tablet device in response to the confirmation request by the notification unit; a second determination unit that determines whether the status of the tablet device acquired by the acquisition unit is valid or not; and a first controller that controls a function of the tablet device to be enabled or disabled based on the status of the tablet device.

In the above information processing apparatus, the first controller may control the function of the tablet device to be enabled when the second determination unit determines that the status of the tablet device is valid. The first controller may control the function of the tablet device to be disabled when the second determination unit determines that the status of the tablet device is invalid.

In the above information processing apparatus, the notification unit may notify the confirmation request when the first determination unit determines that the open/close state of the display panel is changed.

The above information processing apparatus may further include: a third determination unit that determines whether or not the open/close state of the display panel is a predetermined state when an operating system of the information processing apparatus is activated, based on the detection signal generated by the generation unit; and a second controller that controls the function of the tablet device to be disabled based on a result of the third determination unit.

In the above information processing apparatus, the second controller may control the function of the tablet device to be disabled when the third determination unit determines that the open/close state of the display panel is the predetermined state when the operating system of the information processing apparatus is activated. The notification unit may notify the confirmation request when the third determination unit determines that the state of the display panel is not the predetermined state when the operating system of the information processing apparatus is activated.

In the above information processing apparatus, the tablet device may be a serial device.

In the above information processing apparatus, the display panel may include either one of a flat panel display integrally formed with the tablet device, and a protection panel that covers the tablet device.

The above information processing apparatus may further include a setting unit that sets the status of the tablet device when the first determination unit determines that the open/close state of the display unit is changed and when an operating system of the information processing apparatus is activated.

An information processing method includes: detecting an open/close state of a display panel to generate a detection signal; first determining whether or not the open/close state of the display panel is changed based on the generated detection signal; notifying a confirmation request for confirming a status of a tablet device; acquiring the status of the tablet device in response to the notified confirmation request; second determining whether the acquired status of the tablet device is valid or not; and controlling a function of the tablet device to be enabled or disabled based on a result of a determination of the status of the tablet device.

The above information processing method may further include setting the status of the tablet device when it is determined that the open/close state of the display panel is changed.

In the above information processing method, the controlling step may control the function of the tablet device to be enabled when the second determining step determines that the acquired status of the tablet device is valid. The controlling step may control the function of the tablet device to be disabled when the second determining step determines that the acquired status of the tablet device is invalid.

An information processing apparatus includes: a housing; a display panel pivotably attached to the housing; a tablet device that is mounted on the display and receives an input operation by a user; a detector that detects an open/close state of the display panel; a first controller that determines whether or not the open/close state of the display panel is changed based on a result of the detector; and a second controller that (a) sets a validity of the tablet device when the first controller determines the open/close state of the display panel is changed, (b) acquires the validity of the tablet device when a predetermined condition is satisfied, and (c) controls a function of the tablet device to be enabled or disabled based on the acquired validity of the tablet device.

In the above information processing apparatus, the second controller may include a basic input output system (BIOS) and an operating system (OS). The BIOS may set the validity of the tablet device when the controller determines the open/close state of the display panel is changed. The OS may acquire the validity of the tablet device when the predetermined condition is satisfied. The OS may control the function of the tablet device to be enabled or disabled based on the acquired validity.

In the above information processing apparatus, the tablet device may receive the input operation only when the display panel is open. The second controller may set the validity of the tablet device as valid when the first controller determines that the display panel is changed to be open. The second controller may set the validity of the tablet device as invalid when the first controller determines that the display panel is changed to be closed.

In the above information processing apparatus, the predetermined condition may include that the first controller determines the open/close state of the display panel is changed based on the result of the detector.

In the information processing apparatus, the predetermined condition may include that an operating system of the information processing apparatus is activated.

In the information processing apparatus, the second controller may control the function of the tablet device to be disabled when the first controller determines that the state of the display panel is a predetermined state when an operating system of the information processing apparatus is activated.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus comprising:
a signal generation unit that detects an open/close state of a display panel to generate a detection signal;
a first determination unit that determines whether or not the open/close state of the display panel is changed based on the detection signal generated by the generation unit;
a notification unit that notifies a confirmation request for confirming the status of the tablet device;
an acquisition unit that acquires the status of the tablet device in response to the confirmation request by the notification unit;
a second determination unit that determines whether the status of the tablet device acquired by the acquisition unit is valid or not; and
a first controller that controls a function of the tablet device to be enabled or disabled based on the status of the tablet device.

2. The information processing apparatus according to claim 1,
wherein the first controller controls the function of the tablet device to be enabled when the second determination unit determines that the status of the tablet device is valid, and
wherein the first controller controls the function of the tablet device to be disabled when the second determination unit determines that the status of the tablet device is invalid.

3. The information processing apparatus according to claim wherein the notification unit notifies the confirmation request when the first determination unit determines that the open/close state of the display panel is changed.

4. The information processing apparatus according to claim 1, further comprising:
a third determination unit that determines whether or not the open/close state of the display panel is a predetermined state when an operating system of the information processing apparatus is activated, based on the detection signal generated by the generation unit; and
a second controller that controls the function of the tablet device to be disabled based on a result of the third determination unit.

5. The information processing apparatus according to claim 4,
wherein the second controller controls the function of the tablet device to be disabled when the third determination unit determines that the open/close state of the display panel is the predetermined state when the operating system of the information processing apparatus is activated, and
wherein the notification unit notifies the confirmation request when the third determination unit determines that the state of the display panel is not the predetermined state when the operating system of the information processing apparatus is activated.

6. The information processing apparatus according to claim 1,
wherein the tablet device is a serial device.

7. The information processing apparatus according to claim 1,
wherein the display panel includes either one of a flat panel display integrally formed with the tablet device, and a protection panel that covers the tablet device.

8. The information processing apparatus according to claim 1, further comprising a setting unit that sets the status of the tablet device when the first determination unit determines that the open/close state of the display unit is changed and when an operating system of the information processing apparatus is activated.

9. An information processing method comprising:
detecting an open/close state of a display panel to generate a detection signal;
first determining whether or not the open/close state of the display panel is changed based on the generated detection signal;
notifying a confirmation request for confirming a status of a tablet device;
acquiring the status of the tablet device in response to the notified confirmation request;
second determining whether the acquired status of the tablet device is valid or not; and
controlling a function of the tablet device to be enabled or disabled based on a result of a determination of the status of the tablet device.

10. The information processing method according to claim 9, further comprising setting the status of the tablet device when it is determined that the open/close state of the display panel is changed.

11. The information processing method according to claim 9,
wherein the controlling step controls the function of the tablet device to be enabled when the second determining step determines that the acquired status of the tablet device is valid, and
wherein the controlling step controls the function of the tablet device to be disabled when the second determining step determines that the acquired status of the tablet device is invalid.

12. An information processing apparatus comprising:
a housing;
a display panel pivotably attached to the housing;
a tablet device that is mounted on the display and receives an input operation by a user,;
a detector that detects an open/close state of the display panel;
a first controller that determines whether or not the open/close state of the display panel is changed based on a result of the detector; and
a second controller that
(a) sets a validity of the tablet device when the first controller determines the open/close state of the display panel is changed,
(b) acquires the validity of the tablet device when a predetermined condition is satisfied, and
(c) controls a function of the tablet device to be enabled or disabled based on the acquired validity of the tablet device.

13. The information processing apparatus according to claim 12,
wherein the second controller comprises a basic input output system (BIOS) and an operating system (OS), and
wherein the BIOS sets the validity of the tablet device when the controller determines the open/close state of the display panel is changed,
wherein the OS acquires the validity of the tablet device when the predetermined condition is satisfied, and
wherein the OS controls the function of the tablet device to be enabled or disabled based on the acquired validity.

14. The information processing apparatus according to claim 12,
wherein the tablet device receives the input operation only when the display panel is open,
wherein the second controller sets the validity of the tablet device as valid when the first controller determines that the display panel is changed to be open, and
wherein the second controller sets the validity of the tablet device as invalid when the first controller determines that the display panel is changed to be closed.

15. The information processing apparatus according to claim 12,
wherein the predetermined condition includes that the first controller determines the open/close state of the display panel is changed based on the result of the detector.

16. The information processing apparatus according to claim 12,
wherein the predetermined condition includes that an operating system of the information processing apparatus is activated.

17. The information processing apparatus according to claim 12,
wherein the second controller controls the function of the tablet device to be disabled when the first controller determines that the state of the display panel is a predetermined state when an operating system of the information processing apparatus is activated.
